(19) United States
(12) Patent Application Publication
(10) Pub. No.: US 2025/0077888 A1
(43) Pub. Date: Mar. 6, 2025

(54) PREDICTING LOCAL LAYOUT EFFECTS USING A VARIATIONAL AUTOENCODER WITH INTEGRATED REGRESSION AND CLASSIFICATION NETWORK

(71) Applicant: INTERNATIONAL BUSINESS MACHINES CORPORATION, ARMONK, NY (US)

(72) Inventors: MICHAEL DANIEL MONKOWSKI, NEW WINDSOR, NY (US); MICHAEL KAZDA, POUGHKEEPSIE, NY (US); MARK WEGMAN, MOUNT KISCO, NY (US); RICHARD ANDRE WACHNIK, MOUNT KISCO, NY (US)

(21) Appl. No.: 18/459,803

(22) Filed: Sep. 1, 2023

(51) Int. Cl. G06N 3/098; G06N 3/0455

(52) U.S. Cl. CPC G06N 3/098; G06N 3/0455

(57) ABSTRACT

Predicting local layout effects using a variational autoencoder with integrated regression and classification network including identifying a vector of features and a vector of output metrics from a dataset; performing basic training of a neural network machine learning variational autoencoder (VAE) combined with a regression network using the vector of features and the vector of output targets constrained to a latent space of the VAE; performing interpolation training of the VAE and combined regression network; determining a set of influential features of an integrated circuit layout based on an input gradient using an output of the VAE and combined regression network with interpolation training; using the set of influential features as input into a parallel neural network to generate a function for each influential feature; and creating a compact model to calculate local layout effects based on the functions for each influential feature.

### BACKGROUND

### Field of the Disclosure

The field of the disclosure is data processing, or, more specifically, methods, apparatus, and products for predicting local layout effects using a variational autoencoder with integrated regression and classification network.

### Description Of Related Art

Models for local layout effects (LLEs) are generally parametric models. If an observation is made that a device does not fit the current model, its structure is compared to similar devices to determine any differences. The dimension that measures that difference is added as a parameter to the model. A set of devices are constructed that vary this parameter. Measurements are made and the results are fitted to a function of the parameter, and the function is added to the model. Such a process is complex and imprecise.

### SUMMARY

Exemplary embodiments include a method, apparatus, and products for predicting local layout effects using a variational autoencoder with integrated regression and classification network. A method according to an embodiment includes identifying a dataset from a database of integrated circuit layouts of integrated circuits and electrical measurements of the integrated circuits; identifying a vector of features and a vector of output metrics from the dataset; performing basic training of a neural network machine learning variational autoencoder (VAE) combined with a regression network using the vector of features and the vector of output targets constrained to a latent space of the VAE; performing interpolation training of the VAE and combined regression network using the vector of features and the vector of output metrics to generate interpolated vectors for interpolation training; determining a set of influential features of an integrated circuit layout based on an input gradient using an output of the VAE and combined regression network with interpolation training; using the set of influential features as input into a parallel neural network to generate a function for each influential feature; and creating a compact model to calculate local layout effects based on the functions for each influential feature.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an example computing system configured for predicting local layout effects using a variational autoencoder with integrated regression and classification network in accordance with embodiments of the present disclosure.

FIG. 2 shows a block diagram of a system configured for predicting local layout effects using a variational autoencoder with integrated regression and classification network in accordance with embodiments of the present disclosure.

FIG. 3 is a schematic and block diagram of an example variational autoencoder combined with a regression network model of the system of FIG. 2 according to some embodiments of the present disclosure.

FIG. 4 is a schematic and block diagram of an example parallel neural network model of the system of FIG. 2 according to some embodiments of the present disclosure.

FIG. 5 is a flowchart of an example method for predicting local layout effects using a variational autoencoder with integrated regression and classification network according to some embodiments of the present disclosure.

### DETAILED DESCRIPTION

In one embodiment, a disclosed system uses an offline machine learning neural network model comprising a variational autoencoder (VAE) to provide dimensionality reduction combined with a regression network to generate the prediction of local layout effects for a given integrated circuit (IC) design. By combining the VAE with the regression network, the system is trained to model those features that influence the regression while at the same time obtaining the benefits of a VAE, which include the construction of a constrained latent space and a generalization of the input features. Because the latent space is centered around the origin, we can use the radius of a point in latent space to compare to the radii of our training points in latent space to determine whether we are in-domain or out-of-domain of our training. Neural networks cannot extrapolate, and neural networks can only interpolate where they have been trained, so if interpolation is attempted in latent space that has not been trained, an unreliable prediction results. If a simple autoencoder is used to reduce the dimensionality, it cannot be easily determined whether the data points are in a part of latent space that has been trained because the data points could be mapped anywhere. A VAE, on the other hand, constrains the latent space, so that all of the data points map near each other in latent space.

In one embodiment, a system receives a historical dataset, which comprises features and metrics from layouts and physically measured parameters from IC designs. The target metrics can include electrical measurements such as, for example, threshold voltage, drive current, circuit power, and circuit delay. The system performs training of the VAE along with the regression network using the historical dataset to provide a training data representation of the dataset constrained to a latent space of the VAE.

In one embodiment, a disclosed system performs interpolation training to smooth training data points in the latent space and minimize the reconstruction error for interpolated values to enable more accurate parameter predictions. The system can interpolate sampled points from the machine learned latent space representation of the dataset.

In one embodiment, the system applies an input gradient to the input and output of the VAE along with the regression network to determine a set of influential features of a given IC layout. Specifically, the system computes the gradient of the output with respect to the input features, which dictates the magnitude and direction of the movement of the inputs to increase or decrease the output by some amount. If movement of an input results in little or no movement in the output, then the input feature is not influential. If a small change in the input causes a large change in the output, then the feature is highly influential. Once determined, the highly influential features are selected. Similarly, the system may compute the gradient of the output with respect to the latent space dimensions to determine a direction to move in latent space to increase or decrease the output.

In one embodiment, the system creates a compact model that sums the influences from each parameter of each layer using the selected set of influential features as input into a parallel neural network. The parallel neural network generates a function for each influential feature and sums the functions to create the compact model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

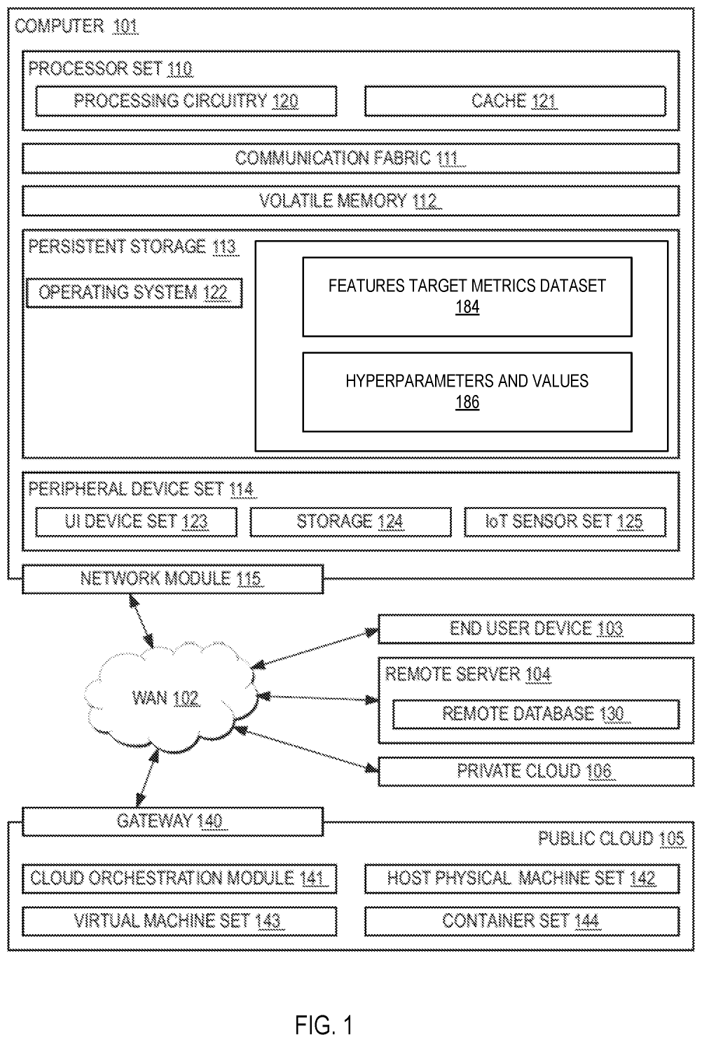

Referring to FIG. 1, a computing environment 100 contains an example of an environment for the execution of at least some of the computer code involved in performing the inventive methods, such as a Parameter Prediction Control Component 182, a Features Target Metrics Dataset 184, and Hyper-parameters and Values 186 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the disclosure provide systems and methods for implementing the prediction of LLEs for a given IC design avoiding the generally complex and imprecise nature of traditional parametric models. In a disclosed embodiment, a system receives pixelated images of IC layers and generates a compact model to calculate LLEs for circuit simulation.

The system uses a machine learning neural network model comprising a Variational Autoencoder (VAE) to provide dimensionality reduction combined with a regression model to predict LLEs for the given IC design. The system uses a dataset of pixelated images of IC layers and physically measured electrical measurements for basic training the VAE and combined regression network together. The VAE and combined regression network generate predictions of LLEs, such as threshold voltage, drive current, circuit power, and circuit delay for the given IC design. The VAE and combined regression network may also be used to generate predictions of non-electrical measurements as target values. Examples may include yield, defectively, measured line width, and measured space.

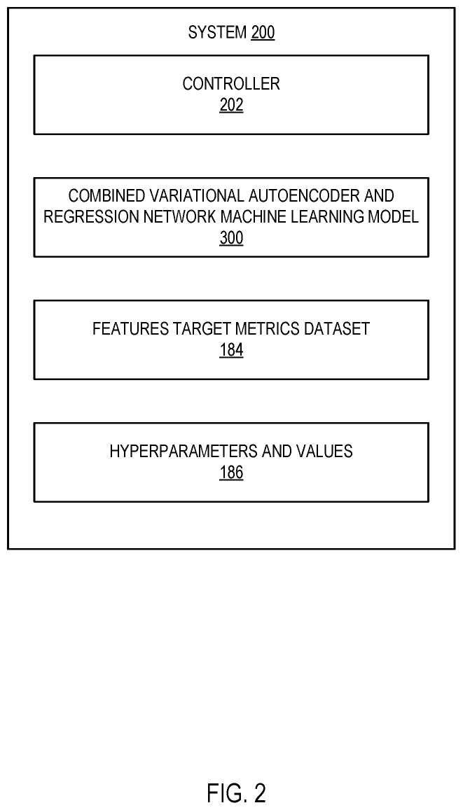

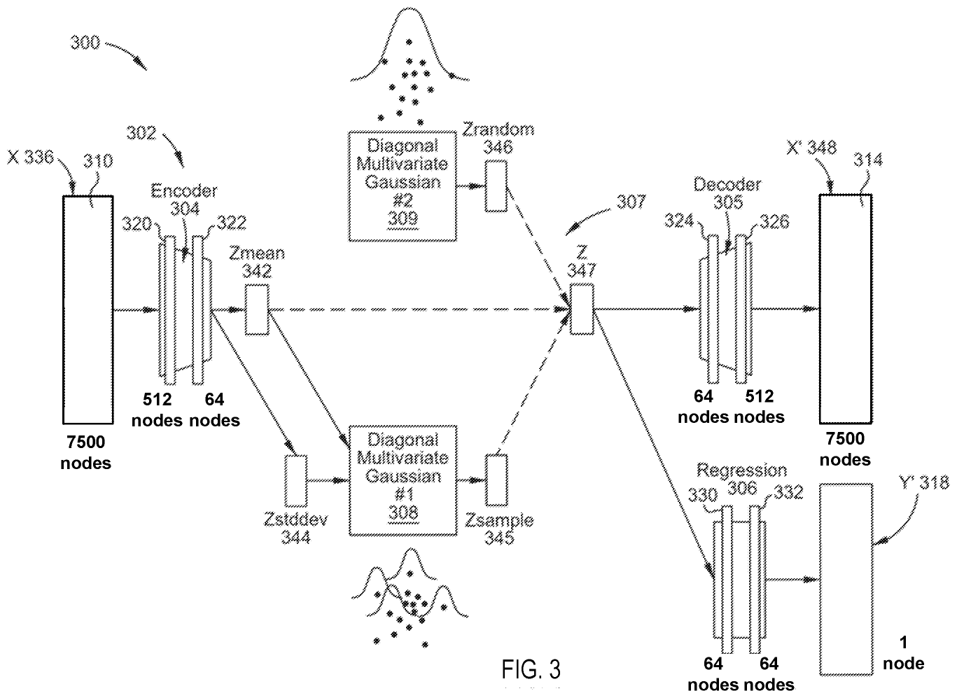

FIG. 2 illustrates an example system 200 for implementing enhanced parameter prediction of one or more disclosed embodiments. System 200 uses a machine learning neural network model 300 comprising a Variational Autoencoder (VAE) combined with a regression network model, such as illustrated in FIG. 3 for implementing the enhanced parameter prediction.

System 200 can efficiently and effectively implement the prediction of LLEs using offline machine learning with machine learning neural network model 300. System 200 includes a controller 202, for example with the processor computer 101 in FIG. 1, for controlling operations of the machine learning neural network model 300 for implementing prediction of LLEs. In a disclosed embodiment, system 200 includes a Features Target Metrics Dataset 184, and Hyper-parameters and Values 186, used with the controller 202 and processor computer 101.

System 200 uses the Features Target Metrics Dataset 184, which comprises pixelated images of IC layouts and electrical measurements, for training the machine learning neural network model 300. In one embodiment, system 200 uses the Hyper-parameters and Values 186, for example weights for regression, reconstruction, and regularization of the machine learning neural network model 300.

Referring to FIG. 3, an illustrated example structure of the offline machine learning neural network model 300 comprises a Variational Autoencoder (VAE) 302 to provide dimensionality reduction combined with a regression network 306 of disclosed embodiments. The VAE 302 and combined regression network 306 predict LLEs for a given IC design of disclosed embodiments.

In a disclosed embodiment, the VAE 302 provides dimensionality reduction, constrains the latent space 307 and enables interpolation of sampled points from the machine learned latent space representation of the Features Target Metrics Dataset 184 in the latent space 307. TensorFlow and Keras layers can be used, for example to implement the VAE 302. TensorFlow is an open-sourced end-to-end platform for performing a library for multiple machine learning tasks, while Keras is a high-level neural network library that runs on top of TensorFlow. Both provide high-level Application Programming Interfaces (APIs) used for building and training models.

The VAE 302 of the machine learning neural network model 300 comprises a neural network encoder 304, a neural network decoder 305, and a latent space generally indicated by 307. The regression network 306 is used with the VAE 302 for training and inference operations of disclosed embodiments. The encoder 304, decoder 305 and latent space 307 of the VAE 302 combined with the regression network 306 of disclosed embodiments generate predictions of LLEs for a given IC design.

The latent space 307 of the VAE 302 implements a machine learned latent space representation of an input training Features Target Metrics Dataset 184 to the encoder 304 of the combined VAE 302 and regression network 306 of disclosed embodiments. The latent space 307 comprises for example, a random sample layer composed of multiple nodes, such as 35 nodes. Each node of the example 35 latent space nodes represents one dimension of the latent space 307. The latent space 307 can be sampled using a first Diagonal Multivariate Gaussian #1, 308 or a second Diagonal Multivariate Gaussian #2, 309. The first Diagonal Multivariate Gaussian #1, 308 is used for basic training and interpolation training of the VAE 302 with the combined regression network 306 of disclosed embodiments. Using the Features Target Metrics Dataset 184, the neural network learns means, Zmean 342, and standard deviations, Zstddev 344, corresponding to each point in latent space 307, which are used by the Diagonal Multivariate Gaussian #1 308 to generate sample vectors Zsample 345. The second Diagonal Multivariate Gaussian #2, 309 is used for generating interpolation vectors for interpolation training of disclosed embodiments. Using the Features Target Metrics Dataset 184, a Diagonal Multivariate Gaussian #2 309 is fitted to all of the points in latent space 307 corresponding to all of the vectors in the Features Target Metrics Dataset 184, and is used to generate sample vectors Zrandom 346.

As shown in the machine learning neural network model 300 of FIG. 3, a data input layer X 336 of the encoder 304 represents pixelated images of IC layers 310 of the Features Target Metrics Dataset 184 with target outputs of the regression network 306 comprising target outputs Y′ 318. A decoded or reconstructed output X′ 348 of decoder 305 comprises reconstructed pixelated images of IC layers 314. For example, the Features Target Metrics Dataset 184 of FIG. 2 is obtained from historical images of historical IC designs. The target outputs Y′ 318 of the regression network 306 includes selected targets, such as threshold voltage, drive current, circuit power, and circuit delay. The physically measured parameters are compared to the predicted output Y′ 318 during training. Training attempts to get the predictions to match the measurements.

In one disclosed embodiment of VAE 302 of system 200, the example neural network encoder 304 comprises two fully connected dense layers 320, 322 with a Rectified Linear Unit (ReLU) activation function. Encoder 304 comprises a plurality of nodes on the outer layer 320 (e.g., 512 nodes) and a plurality of nodes on the inner layer 322 (e.g., 64 nodes). The ReLU activation function in the neural network encoder 304 can define how a weighted sum of an input is transformed into an output of the neural network encoder. For example, the ReLU activation function of the encoder 304 can include a piecewise linear function that outputs the input directly if it is positive, or otherwise output zero. The example model encoder 304 using the ReLU activation function may be relatively easy to train to achieve effective performance of the VAE 302.

In a disclosed embodiment, an example decoder 305 of VAE 302 can be configured as the converse of the encoder 304. As shown, the decoder 305 comprises two fully connected layers 324, 326 for example with the ReLU activation function, the first plurality of nodes on the inner layer 324 (e.g., 64 nodes) and the second plurality of nodes on the outer layer 326 (e.g., 512 nodes) with a sub plurality of output nodes (e.g., 7500 nodes) of the decoded output X′ 348 of decoder 305 using linear activation for reconstruction.

For example, the data input layer X 336 of encoder 304 comprises a plurality of input nodes, such as 7500 nodes representing a vectorized mapping of 12 design layers each 25 by 25 pixels for both the input and output.

In a disclosed embodiment, the regression network 306 can include two fully connected layers 330, 332, each with 64 nodes using a Tanh activation function and one node using linear activation on the target outputs Y′ 318. For example, the Tanh activation function is a hyperbolic tangent sigmoid function having a range of −1 to 1 and can model nonlinear boundaries. The Tanh activation function can be applied at different scales without losing its effectivity. In system 200, the target outputs Y′ 318 of the regression network 306 can comprise measured values such as threshold voltage, drive current, circuit power, and circuit delay. It should be obvious to one skilled in the art that other measured parameters, both electrical and non-electrical, may be used as Target Metrics.

As shown in FIG. 3, multiple configurations of the VAE 302 are provided including separate configurations of the encoder 304, decoder 305, and the regression network 306 depending on the data flow for training, inference and optimization operations. As shown, a separate path illustrated by dotted lines provides a respective connection to a connecting point or connecting block Z 347 of the latent space 307 from Zmean 342, Zsample 345, or Zrandom 346. The block Z 347 is not a layer, block Z 347 represents a connection of the three alternative VAE configurations of Zmean 342 for inference operations, Zsample 345 for training operations, or Zrandom 346 for interpolation training and optimization operations. As shown, VAE 302 includes one of the alternative connections of Zmean 342, Zsample 345, or Zrandom 346 via connecting block Z 347 to the decoder 305 and the regression network 306.

Sampling with the first Diagonal Multivariate Gaussian #1 308 provides Zsample 345, which is used during basic training and interpolation training of VAE 302, but not during inference. The Zsample 345 of first Diagonal Multivariate Gaussian #1 308 is centered around each one of Zmeans of the training data including some standard deviation Zstddev 344 relative to the Zmean. The output Zrandom 346 of the second Diagonal Multivariate Gaussian #2 309 is used for generating interpolation vectors. The output Zrandom 346 of the second Diagonal Multivariate Gaussian #2 309 is a single distribution with a zero mean and a standard deviation equal to the root mean square of the Zmean 342 of the training data.

The VAE 302 combined with the regression network 306 are trained together (e.g., trained simultaneously) using the Features Target Metrics Dataset 184 to constrain the latent space 307 and provide a latent space representation of the dataset. The VAE 302 constrains the latent space 307 so that all training data points map near each other in the latent space 307. During basic and interpolation training of the VAE 302, the first Diagonal Multivariate Gaussian #1, 308 samples outputs Zmean 342 and Zstddev 344 of the encoder 304, providing output Zsample 345.

During training the data flow output Zmean 342 represents a mean value of encoded latent space sampled points, and the Zstddev 344 represents a variance or standard deviation value of the sampled points. The encoded data Zmean 342 and Zstddev 344 are applied to the first Diagonal Multivariate Gaussian #1, which during basic training and interpolation training of the VAE 302 provides traditional VAE sampling and the data flow output Zsample 345. Data points of the first Diagonal Multivariate Gaussian #1, 308 are applied to the decoder 305 and the regression network 306.

An example schematic illustration of first training data sample distributions in latent space 307 shown below the first Diagonal Multivariate Gaussian #1, 308 represents an example output Zsample 345 of the first Diagonal Multivariate Gaussian #1, 308. The points represent the Zmean 342 positions in latent space 307, and the curves represent the Gaussian distributions around the Zmean 342 positions with standard deviations Zstddev 344. Although only four distributions are shown, there is actually a distribution around every Zmean 342 position. We show only four for clarity. An example schematic illustration of a second training data sample distribution in latent space 307 shown above the second Diagonal Multivariate Gaussian #2, 309 represents output Zrandom 346 of the second Diagonal Multivariate Gaussian #2, 309. Both the first and second illustrations include the same training data points representing encoder output Zmean 342. Each of the training data points represents images of IC layers and electrical parameters from a specific historical IC design obtained from Features Target Metrics Dataset 184.

For the first Diagonal Multivariate Gaussian #1, 308 each of the data training points has distributions in every dimension of the latent space 307, however, the illustrated four data training distributions are shown in only one dimension. In the first Diagonal Multivariate Gaussian #1, 308, each of the four training data distributions is centered around one of four Zmeans with standard deviation Zstddev relative to the respective Zmean. The illustrated training data sample distributions represent the sampling output Zsample 345 in latent space 307 of the first Diagonal Multivariate Gaussian #1, 308.

For the second Diagonal Multivariate Gaussian #2, 309, there is only one distribution in the latent space 307. The single distribution of output Zrandom 346 has multiple dimensions of the latent space 307 but the illustrated training distribution is shown in one dimension. As shown, the output Zrandom 346 of the second Diagonal Multivariate Gaussian #2, 309 is used for generating interpolation vectors for interpolation training and initialization of an optimization gradient search of optimization operations by transforming from latent space to input space using the decoder network and the regression network. The interpolated vectors and their corresponding predicted output values are combined with the original training vectors and are regenerated every epoch of training. The output Zrandom 346 is a single distribution that has a zero mean and the standard deviations for each dimension equal to the root-mean-square (RMS) of the Zmeans of the training data.

In system 200, the images of IC layers 310 may include images of layer layouts for an active layer, an isolation layer, a gate cut layer, a contacts layer, a vias layer, a metal layer, a well layer, and a threshold voltage implant layer. The images may be, for example, 25 by 25 pixels in size. Each 25 by 25 grid of pixels may be centered on the center of the active gate. Alternatively, the grid may be centered on a feature that captures the regularity of the environment. The values for each pixel represent the average density for that layer within the area defined by that pixel, which is the fraction of the area covered by shapes on that layer. The density values may be organized into an array with dimensions (device, x, y, layer) or may be flattened to a one-dimensional vector for each device for input to the neural network. The input features may consist of density values between zero and one, and may not be normalized. For the y values, the mean is subtracted.

Hyperparameters and values 186 provide for example, a regression weight, a reconstruction weight, and an L2 regularization weight, a training data batch size, such as 256, 512, or 1024, a number of epochs, such as 15,000 epochs.

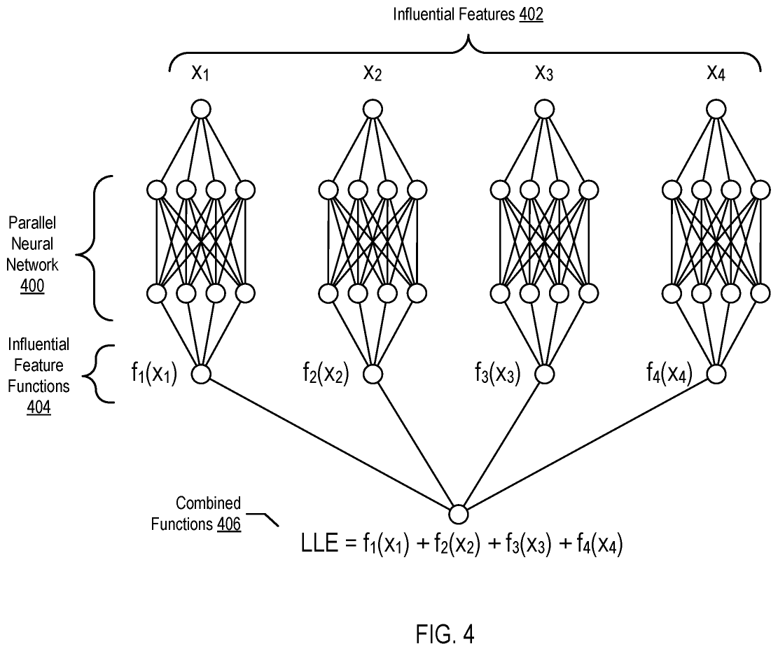

Referring to FIG. 4, an illustrated example structure of a parallel neural network 400 is shown. The example parallel neural network 400 may include one node per influential feature determined from the input gradient and VAE 302 combined with the regression network 306. To obtain the influential features, a determination of the changes to the input features that have an effect on the output LLE is made. The input gradient may be used for this determination. The input gradient generates information regarding the presence or absence of a pixel that influences the value of the LLE parameter. The input gradient is the partial derivative of the output with respect to the input. Because IC devices are insensitive to mirroring, the layer images may be smoothed by averaging over the mirror images with well-chosen mirror planes.

When the regularization is set to a value that allows for visualization of the input gradient, the input gradient closely resembles the product of the network weights. This behavior is expected for linear activations, but not for non-linear activations. This behavior is useful for tuning the regularization. The plot of the product of the weights versus the mean input gradient shows the quality of the correlation. With less regularization, the correlation degrades. With too much regularization, the correlation also degrades.

Once the influential features are determined, the influential features are used as input into the parallel neural network 400. Specifically, each influential feature 402 X is determined based on the magnitude of the effect on the selected electrical parameter (e.g., threshold voltage). Those features are processed by the parallel neural network 400 to determine a function that describes the influential feature. A simplifying assumption is made that the features are independent and the sum of the features provides the total change to the LLE parameter. However, networks more complicated than parallel may be used.

The parallel neural network 400 may include one node per influential feature 402 each connected to 32 nodes per feature, and another 32 nodes per feature before being concatenated into one node per influential feature function 404. Finally, each influential feature function 404 is combined into the combined functions 406 for the LLE parameter.

The influential features may be trained using the combined influential feature function predicted by the VAE 302 to remove measurement noise. The combined functions 406 may be graphed along with the training data and the curves may be fit to a parametric equation and used as the compact model. Because the features are additive, they each have a share of the total constant offset, so the mean is subtracted from the feature predictions.

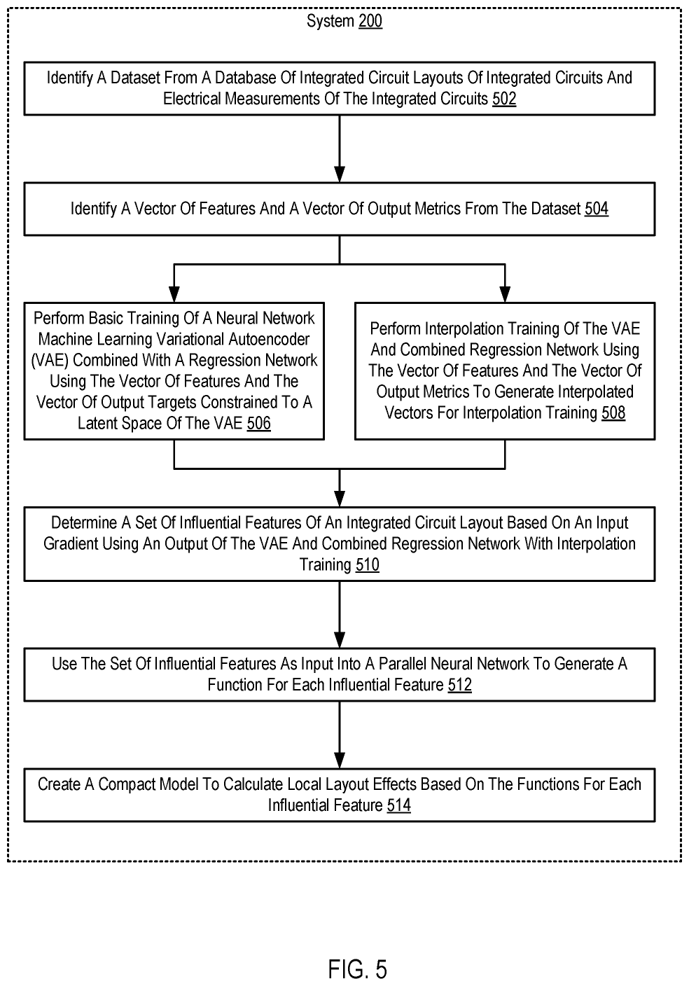

Referring to FIG. 5, system 200 implements operations of an example method, for example, using the Features Target Metrics DataSet 184, and Hyperparameters and Values 186, with the controller 202, together with processor computer 101 of FIG. 1. In FIG. 5, the same reference numbers are used for identical or similar components of FIGS. 2, 3, and 4.

As indicated at block 502, system 200 identifies a dataset from a database of integrated circuit layouts of integrated circuits and electrical measurements of the integrated circuits and receives the Features Target Metrics Dataset 184 for simultaneously training the VAE 302 and regression network 306. The Features Target Metrics Dataset 184 used for training the VAE 302 and regression network 306 comprises images of IC layers 310.

At block 504, system 200 identifies a vector of features and a vector of output metrics from the dataset to use for training the VAE 302 and regression network 306. At block 506, system 200 performs basic training of a neural network machine learning variational autoencoder (VAE) combined with a regression network using the vector of features and the vector of output targets constrained to a latent space of the VAE 302. System 200 provides or builds a machine learning neural network model 300 comprising the VAE 302 to provide dimensionality reduction combined with the combined regression network 306, to obtain a prediction of optimal design flow parameters of disclosed embodiments. FIG. 3 as described above schematically illustrates the structure of the VAE 302 and the combined regression network 306. At block 408, system 200 can perform optional basic training of the VAE 302 along with the regression network 306 using the identified vectors at block 404 to provide a training data representation of the dataset constrained to a latent space 307 of the VAE 302. System 200 can perform training of the VAE 302 along with the regression network 306 using unsupervised machine learning with a vector of training data features and supervised machine learning with a vector of training data output targets to provide the training data representation of the dataset constrained to the latent space 307 of the VAE. Note that interpolation training at block 508 is optional.

At block 508 system 200 performs interpolation training of the VAE 302 and combined regression network 306 using the vector of features and the vector of output metrics to generate interpolated vectors for interpolation training. In a disclosed embodiment, interpolation training can provide improved results for LLE prediction over basic training. At block 508, system 200 can use the identified vectors at block 504 to provide a training data representation of the dataset constrained to a latent space 307 of the VAE 302. Also at block 508, system 200 can generate interpolated vectors by sampling the training data representation of the dataset, and running the sampled points through the decoder 305 to produce an augmented dataset each epoch used for the interpolation training operations. The interpolation training provides a form of regularization. The aim of regularization is to allow the encoder 305 to generalize, which is to say interpolate. In one embodiment, additional L2 regularization on the encoder 304 may be employed.

At block 510 system 200 determines a set of influential features of an integrated circuit layout based on an input gradient using an output of the VAE 302 and combined regression network 306 with interpolation training. At block 512 system 200 uses the set of influential features as input into a parallel neural network 400 to generate a function for each influential feature. At block 514 system 200 creates a compact model to calculate LLE based on the functions for each influential feature. The system 200 may further determine that the influential features of the integrated circuit layout are within a domain of training data points in latent space by examining a location of a test data point relative to training data points in the latent space.

In view of the explanations set forth above, readers will recognize that the benefits of predicting local layout effects using a variational autoencoder with integrated regression and classification network according to embodiments of the present disclosure include:
Reduces complexity of predicting IC parameters by using a VAE and regression network to more accurately and reliably predict LLE parameters.
Reduces time required to design ICs by using a VAE and regression network to more accurately and reliably predict LLE parameters.
Reduces incidence of fabricating ICs with unacceptable parameters by using a VAE and regression network to more accurately and reliably predict LLE parameters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Exemplary embodiments of the present disclosure are described largely in the context of a fully functional computer system for predicting local layout effects using a variational autoencoder with integrated regression and classification network. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for predicting local layout effects using a variational autoencoder with integrated regression and classification network, the method comprising:
identifying a dataset from a database of integrated circuit layouts of integrated circuits and electrical measurements of the integrated circuits;
identifying a vector of features and a vector of output metrics from the dataset;
performing basic training of a neural network machine learning variational autoencoder (VAE) combined with a regression network using the vector of features and the vector of output targets constrained to a latent space of the VAE;
performing interpolation training of the VAE and combined regression network using the vector of features and the vector of output metrics to generate interpolated vectors for interpolation training;
determining a set of influential features of an integrated circuit layout based on an input gradient using an output of the VAE and combined regression network with interpolation training;
using the set of influential features as input into a parallel neural network to generate a function for each influential feature; and
creating a compact model to calculate local layout effects based on the functions for each influential feature.

2. The method of claim 1, further comprising:
determining that the influential features of the integrated circuit layout are within a domain of training data points in latent space by examining a location of a test data point relative to training data points in the latent space.

3. The method of claim 1, wherein the integrated circuit layout is a layer of an integrated circuit design.

4. The method of claim 1, wherein the compact model is based on a sum of the functions for each influential feature.

5. The method of claim 1, wherein the functions for each influential feature are magnitudes of effects on an electrical parameter.

6. The method of claim 1, wherein the local layout effects comprise one from a group consisting of threshold voltage, drive current, circuit power, and circuit delay.

7. The method of claim 1, wherein the local layout effects comprise one from a group consisting of yield, defectively, measured line width, and measured space.

8. An apparatus for predicting local layout effects using a variational autoencoder with integrated regression and classification network, the apparatus comprising:
a computer processor; and
a computer memory operatively coupled to the computer processor, the computer memory having disposed within it computer program instructions that, when executed by the computer processor, cause the apparatus to:
identifying a dataset from a database of integrated circuit layouts of integrated circuits and electrical measurements of the integrated circuits;
identifying a vector of features and a vector of output metrics from the dataset;
performing basic training of a neural network machine learning variational autoencoder (VAE) combined with a regression network using the vector of features and the vector of output targets constrained to a latent space of the VAE;
performing interpolation training of the VAE and combined regression network using the vector of features and the vector of output metrics to generate interpolated vectors for interpolation training;
determining a set of influential features of an integrated circuit layout based on an input gradient using an output of the VAE and combined regression network with interpolation training;
using the set of influential features as input into a parallel neural network to generate a function for each influential feature; and
creating a compact model to calculate local layout effects based on the functions for each influential feature.

9. The apparatus of claim 8, wherein the computer program instructions further cause the apparatus to carry out the step of:
determining that the influential features of the integrated circuit layout are within a domain of training data points in latent space by examining a location of a test data point relative to training data points in the latent space.

10. The apparatus of claim 8, wherein the integrated circuit layout is a layer of an integrated circuit design.

11. The apparatus of claim 8, wherein the compact model is based on a sum of the functions for each influential feature.

12. The apparatus of claim 8, wherein the functions for each influential feature are magnitudes of effects on an electrical parameter.

13. The apparatus of claim 8, wherein the local layout effects comprise one from a group consisting of threshold voltage, drive current, circuit power, and circuit delay.

14. The apparatus of claim 8, wherein the local layout effects comprise one from a group consisting of yield, defectively, measured line width, and measured space.

15. A computer program product for predicting local layout effects using a variational autoencoder with integrated regression and classification network, the computer program product disposed upon a computer readable medium, the computer program product comprising computer program instructions that, when executed, cause a computer to:
identify a dataset from a database of integrated circuit layouts of integrated circuits and electrical measurements of the integrated circuits;
identify a vector of features and a vector of output metrics from the dataset;
perform basic training of a neural network machine learning variational autoencoder (VAE) combined with a regression network using the vector of features and the vector of output targets constrained to a latent space of the VAE;
perform interpolation training of the VAE and combined regression network using the vector of features and the vector of output metrics to generate interpolated vectors for interpolation training;
determine a set of influential features of an integrated circuit layout based on an input gradient using an output of the VAE and combined regression network with interpolation training;
use the set of influential features as input into a parallel neural network to generate a function for each influential feature; and
create a compact model to calculate local layout effects based on the functions for each influential feature.

16. The computer program product of claim 15, wherein the computer program instructions further cause the apparatus to carry out the step of:
determining that the influential features of the integrated circuit layout are within a domain of training data points in latent space by examining a location of a test data point relative to training data points in the latent space.

17. The computer program product of claim 15, wherein the integrated circuit layout is a layer of an integrated circuit design.

18. The computer program product of claim 15, wherein the compact model is based on a sum of the functions for each influential feature.

19. The computer program product of claim 15, wherein the functions for each influential feature are magnitudes of effects on an electrical parameter.

20. The computer program product of claim 15, wherein the local layout effects comprise one from a group consisting of threshold voltage. drive current, circuit power, and circuit delay.
